(19) United States
(12) Patent Application Publication
(10) Pub. No.: US 2016/0307163 A1
(43) Pub. Date: Oct. 20, 2016

(54) PERSON IS A RESOURCE FOR A CALENDAR INVITE

(71) Applicant: International Business Machines Corporation, Armonk, NY (US)

(72) Inventors: Lisa M. Bradley, Cary, NC (US); Brian O'Donovan, Dublin (IE); Aaron J. Quirk, Cary, NC (US); Lin Sun, Morrisville, NC (US)

(21) Appl. No.: 14/687,196

(22) Filed: Apr. 15, 2015

(51) Int. Cl. G06Q 10/10; G06F 3/0484; H04L 12/58

(52) U.S. Cl. CPC G06Q 10/1095; H04L 51/08; G06F 3/04842

(57) ABSTRACT

A method for requesting a person to be available for a scheduled event is provided. The method may include providing a user interface (UI) for requesting at least one person to be available for an event. The method may also include detecting an entry via the UI requesting at least one person to be available for the event. The method may further include detecting an entry via the UI for at least one invitee to be invited to the event. The method may additionally include confirming an availability of the at least one person and an availability of the at least one invitee. The method may also include sending a unique calendar invitation to the at least one person. The method may include sending a calendar invitation to the at least one invitee based on the confirmed availability of the at least one person and the at least one invitee.

### BACKGROUND

The present invention relates generally to the field of computers, and more particularly to online calendar invitations.

Often when calendar invitations are created, the creator of the invitation may look for a physical resource, such as an available conference room, or may select a particular resource based on the invitees. Additionally, the creator of a calendar invitation may check the availability of the potential invitees of the event prior to scheduling and sending a calendar invitation for the event.

### SUMMARY

According to one embodiment, a method for requesting a person to be available for a scheduled event is provided. The method may include providing a user interface (UI) for requesting at least one person to be available for an event. The method may also include detecting an entry via the UI requesting at least one person to be available for the event. The method may further include detecting an entry via the UI for at least one invitee to be invited to the event. The method may additionally include confirming an availability of the at least one person and an availability of the at least one invitee. The method may also include sending a unique calendar invitation to the at least one person. The method may include sending a calendar invitation to the at least one invitee based on the confirmed availability of the at least one person and the at least one invitee.

According to another embodiment, a computer system for requesting a person to be available for a scheduled event is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include providing a user interface (UI) for requesting at least one person to be available for an event. The method may also include detecting an entry via the UI requesting at least one person to be available for the event. The method may further include detecting an entry via the UI for at least one invitee to be invited to the event. The method may additionally include confirming an availability of the at least one person and an availability of the at least one invitee. The method may also include sending a unique calendar invitation to the at least one person. The method may include sending a calendar invitation to the at least one invitee based on the confirmed availability of the at least one person and the at least one invitee.

According to yet another embodiment, a computer program product for requesting a person to be available for a scheduled event is provided. The computer program product may include one or more computer-readable storage devices and program instructions stored on at least one of the one or more tangible storage devices, the program instructions executable by a processor. The computer program product may include program instructions to receive at least one search term or a social media post entered by the user. The computer program product may also include program instructions to providing a user interface (UI) for requesting at least one person to be available for an event. The method may also include detecting an entry via the UI requesting at least one person to be available for the event. The method may further include detecting an entry via the UI for at least one invitee to be invited to the event. The method may additionally include confirming an availability of the at least one person and an availability of the at least one invitee. The method may also include sending a unique calendar invitation to the at least one person. The method may include sending a calendar invitation to the at least one invitee based on the confirmed availability of the at least one person and the at least one invitee.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is an operational flowchart illustrating the steps carried out by a program that allows a person as a resource for a calendar invitation according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computers, and more particularly to online calendar invitations. The following described exemplary embodiments provide a system, method and program product to, among other things, allow the creator of an online calendar invitation to schedule a person as a resource for a calendar event. Therefore, the present embodiment has the capacity to improve the technical field of online calendar invitations by providing a way to allow a person to act as a resource for a calendar event. More specifically, the present embodiment may allow the creator of the calendar event to be able to check the availability of a person as a resource.

As previously described, when calendar invitations are created, the creator of the invitation may look for a physical resource, such as a location or a projector, that needs to be reserved for an event, or may select a particular resource based on the invitees. Additionally, the creator of a calendar invitation may check the availability of the potential invitees of the event prior to scheduling and sending a calendar invitation for the event.

However, there are many instances when the creator of a calendar invitation may need to check the availability of a person who does not need to attend the event. As such, there may be a situation when a calendar invitation is being created and the creator does not need to invite a particular person to the calendar event, however, the creator may need to make sure that the particular person is free for the time that the creator is scheduling the event. For example, when a person needs to hire a babysitter (or even make sure their spouse is available) to watch their children for a work call that might run later in the day. When the person schedules the work call, they are not going to invite the babysitter (or spouse) to the call, however they need to make sure the babysitter's (or spouse's) calendar availability is free. Currently, when scheduling a calendar event, such as a meeting, the creator of the calendar event would need to first check with the person that the creator needs available via phone or calendar and then after the creator confirms the other person is available, the creator may schedule the calendar event. For example, a creator of a calendar event may create 2 meeting invites. One meeting invite may be for the person that is the resource and the other meeting invite may be for the person who needs to participate in the meeting. Such an implementation does not allow the creator of the calendar invitation to easily notify the person that is the resource about rescheduling information or updates to the meeting.

As such, it may be advantageous, among other things, to allow a person to be a resource that is needed for a calendar entry where the creator of the calendar invitation needs to reserve them and verify they are available, but not actually invite them to the calendar event.

According to at least one implementation, the present embodiment may allow the creator of an online calendar invitation to more efficiently schedule a person as a resource for a calendar event. As such, the present embodiment may allow the creator of the calendar event to be able to check the availability of a person as a resource and automatically book the person as a resource for the calendar event.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product to allow the creator of an online calendar event to check the availability of a person as a resource to the calendar event and book the person as a resource for the calendar event. According to at least one implementation, the present embodiment may allow a person to be a resource that may be needed for a calendar entry, where the creator of the calendar entry needs to reserve them and make sure they are available, but not actually invite them. As such, the creator may request a person to be available for a scheduled event, whereby the person is not invited to attend the event, but may be requested to be available elsewhere during the event.

According to at least one implementation, the person as a resource may be an entry field similar to a resource entry field that exists in calendar applications. As such, the present embodiment may enable the creator of the calendar invitation to be prompted via a user interface (UI) when they book a calendar entry. Therefore, when the creator of the calendar events books the calendar entry, there may be an option for a person as a resource. Additionally, there may be also be an optional comment field where the creator can provide information to just the resource.

Furthermore, the present embodiment may check the schedule of the person as a resource along with the others that are invited to the meeting for available free time. Then, when the creator selects to send out the calendar invite, the person as a resource may receive a unique calendar entry with the information that the creator entered in the comments field. However, the other meeting invitees may receive another invite based on the main calendar entry fields.

Additionally, there may be an option so that the meeting invitees to the calendar entry do not receive a meeting invite until the person that is the resource accepts their calendar invitation. Furthermore, the present embodiment may be able to handle reschedules or updates to the calendar entry. Therefore, the invitees and the person that is the resource will receive updates to their individual invitation.

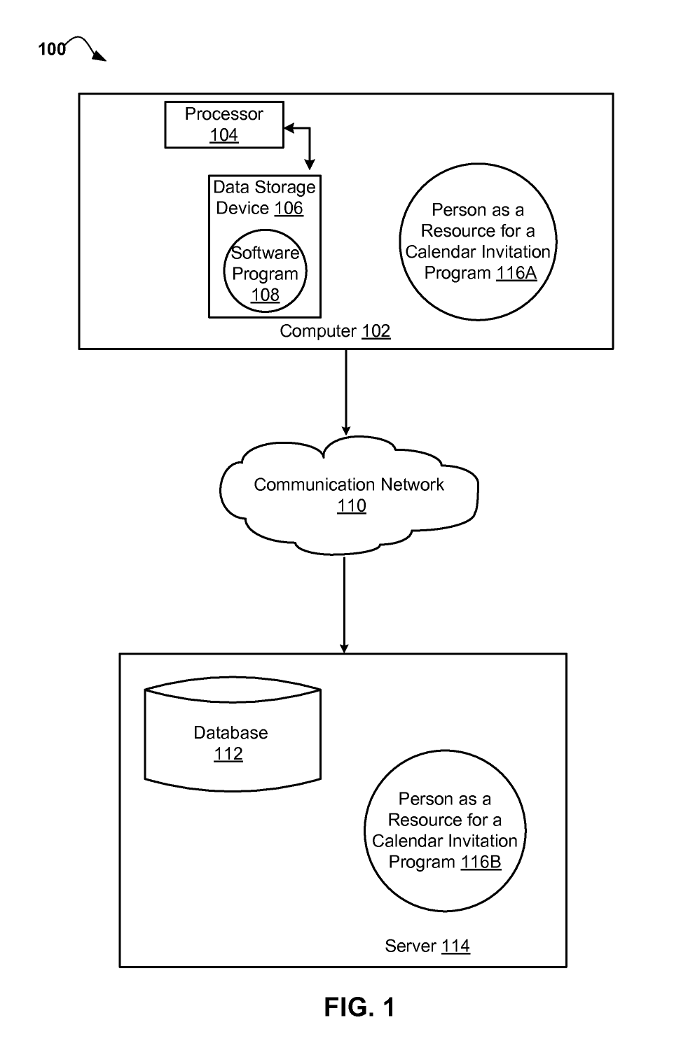

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a Person as a Resource for a Calendar Invitation program 116A. The networked computer environment 100 may also include a server 114 that is enabled to run a Person as a Resource for a Calendar Invitation program 116B that may interact with a database 112 and a communication network 110. The networked computer environment 100 may include a plurality of computer 102 and servers 114, only one of which is shown. The communication network may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

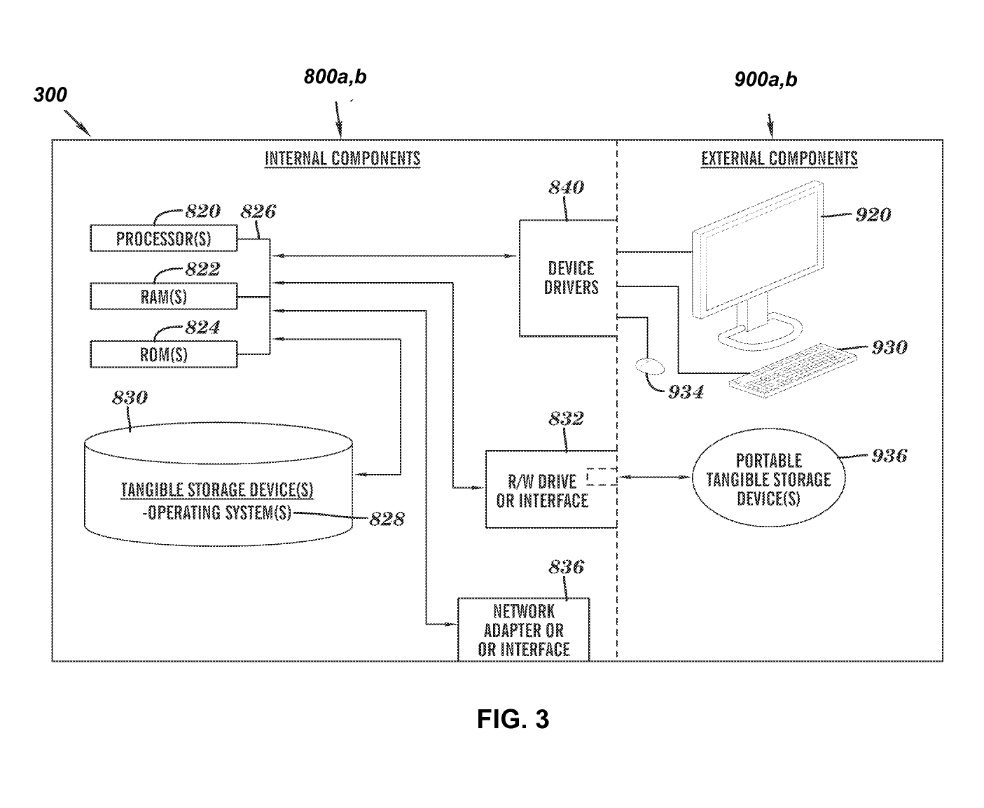

The client computer 102 may communicate with the Person as a Resource for a Calendar Invitation program 116B running on server computer 114 via the communications network 110. The communications network 110 may include connections, such as wire, wireless communication links, or fiber optic cables. As will be discussed with reference to FIG. 3, server computer 114 may include internal components 800a and external components 900a, respectively, and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing devices capable of running a program, accessing a network, and accessing a database 112. According to various implementations of the present embodiment, the Person as a Resource for a Calendar Invitation program 116A, 116B may interact with a database 112 that may be embedded in various storage devices, such as, but not limited to a computer/mobile device 102, a networked server 114, or a cloud storage service.

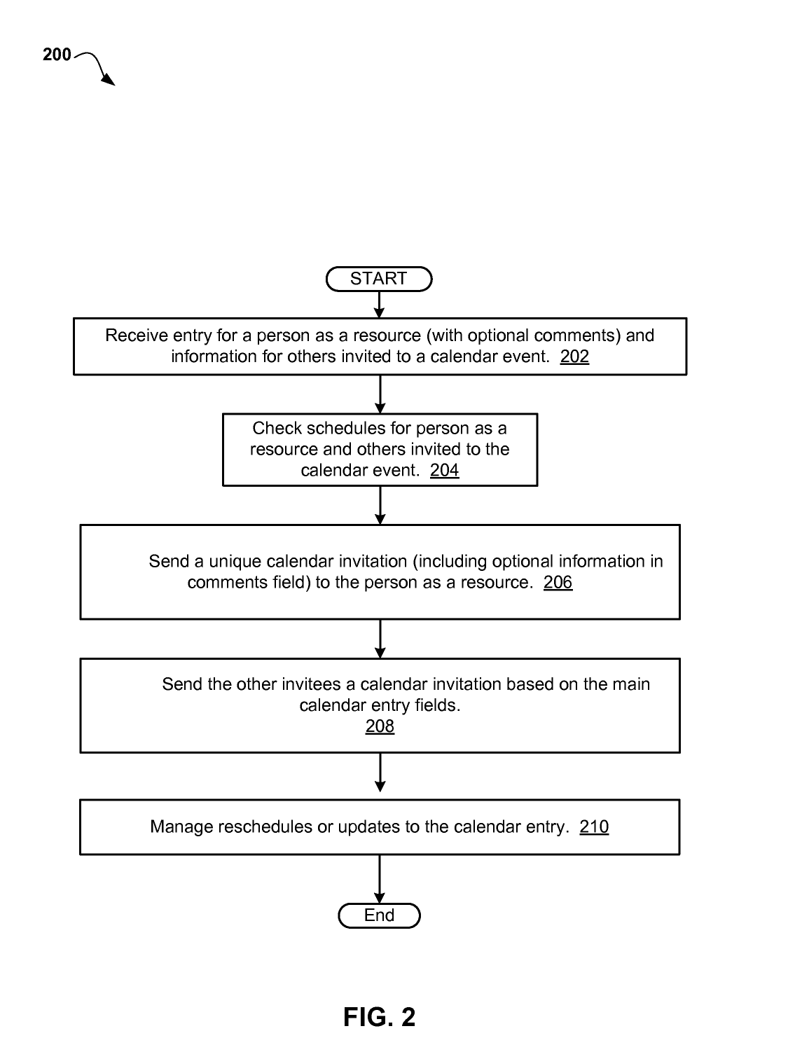

As previously described, the client computer 102 may access the Person as a Resource for a Calendar Invitation program 116B, running on server computer 114 via the communications network 110. For example, a user using a client computer 102 may utilize the Person as a Resource for a Calendar Invitation program 116A, 116B to book a person as a resource when creating a calendar entry. As such, the Person as a Resource for a Calendar Invitation program 116A, 116B may search the availability of a person that is a resource to a calendar event in addition to searching the availability of the invitees to the calendar event. Additionally, there may be also be an optional comment field where the creator of the calendar event can provide information to just the resource. The Person as a Resource for a Calendar Invitation method is explained in more detail below with respect to FIG. 2.

Referring now to FIG. 2, an operational flowchart 200 illustrating the steps carried out by a Person as a Resource for a Calendar Invitation program. As previously described, the Person as a Resource for a Calendar Invitation program 116A, 116B (FIG. 1) may allow a creator of a calendar invitation to book a person as a resource for the calendar invitation. As such, the present embodiment may request a person (i.e., a person as a resource) to be available for a scheduled event. According to at least one implementation, the present embodiment may provide the creator of the calendar event with a user interface (UI) that has an option to request a person to be available for the event. Then, responsive to the user utilizing the UI and requesting a person as a resource, the present embodiment may send a notification to the person for the event whereby the person is not invited to attend the event, but may be requested to be available elsewhere during the event. According to at least one implementation, the event may be selected from a group consisting of, but not limited to a meeting, an appointment, a phone conference, a game, a dinner, a presentation, a scheduled out-of-office, and etc. Additionally, the notification may be a calendar entry for the person to be available during the event and the UI may provide options selected from a group consisting of rescheduling, acceptance ordering rules, dependencies, alternatives, and etc.

Therefore with respect to FIG. 2 at 202, the Person as a Resource for a Calendar Invitation program 116A, 116B (FIG. 1) may receive an entry for a person as a resource (i.e., a request for a person to be available for a calendar event who is not invited to the calendar event) as well as information for other invitees who are invited to the calendar event. As such, according to at least one implementation, the present embodiment may provide the creator of the calendar event with a user interface (UI) that provides an option to request a person (i.e., a person as a resource) to be available for the event in addition to a plurality of main calendar entry fields that allow the creator to invite other invitees to the event. Additionally, the present embodiment may provide an optional comment field where the creator of the calendar event may provide additional information and comments to only the person as a resource.

Next at 204, the Person as a Resource for a Calendar Invitation program 116A, 116B (FIG. 1) may check the schedules (i.e., availability) for the person as a resource and the other invitees of the calendar event. As such, the present embodiment may check the person as a resource's schedule along with the others that have been invited to the calendar event for available free time.

Then at 206, the Person as a Resource for a Calendar Invitation program 116A, 116B (FIG. 1) may send a unique calendar invitation (including the optional information in the comments field) to the person as a resource. As such, the present embodiment may send a notification to the person as a resource whereby the person is not invited to attend the event, but may be requested to be available elsewhere during the event. As previously described, the event may be any calendar event that may be selected from a group consisting of, but not limited to a meeting, an appointment, a phone conference, a game, a dinner, a presentation, a scheduled out-of-office, and etc.

Next at 208, the Person as a Resource for a Calendar Invitation program 116A, 116B (FIG. 1) may send the other invitees a calendar invitation based on the main calendar entry fields. According to at least one implementation, the calendar event invitees to the calendar entry may not receive a meeting invite until the person as a resource accepts their calendar invitation. As such, the calendar event may be contingent upon the availability and acceptance of the person as a resource.

Then at 210, the Person as a Resource for a Calendar Invitation program 116A, 116B (FIG. 1) will manage reschedules or updates to the calendar entry. Therefore, the invitees and person as a resource may receive updates to their individual invitation. As previously described, the notification may be a calendar entry for the person to be available during the event and the UI may provide options selected from a group consisting of rescheduling, acceptance ordering rules, dependencies, alternatives, and etc.

It may be appreciated that FIG. 2 provides only an illustration of one implementation and does not imply any limitations with regard to how different embodiments may be implemented. Many modifications to the depicted environments may be made based on design and implementation requirements. For example, as previously described, the Person as a Resource for a Calendar Invitation program 116A, 116B (FIG. 1) may prompt the creator of the calendar invitation with an option so that the meeting invitees to the calendar entry do not receive a meeting invite until the person that is the resource accepts their calendar invitation.

Additionally, the present embodiment may automatically identify a person to replace a user in a scheduled event (e.g. meeting, phone conference, game, dinner, presentation, out-of-office) if the user is unavailable to attend the scheduled event. More specifically, the present embodiment may automatically request the person to be available for the scheduled event by sending a notification (e.g. calendar entry) to the person and providing an option to the user if the user is unavailable to attend the scheduled event, whereby options may be rescheduling of the meeting, acceptance by the person, dependency on the person or an alternative option for another person.

For example, a possible user of the present embodiment may be a first employee who is scheduling an out of office day or vacation on their calendar. In order to be out of the office, they are required to find a backup second employee to cover for them while away. As such the present embodiment may enable the first employee to schedule their out of office time during a period when the second employee is available. Therefore, the present embodiment may support the concept that in order for person A to be at location A, person B must be at a different location B as a dependency.

Furthermore, the present embodiment may also allow multiple people as the resource or a chain of hierarchy of the resource. For instance, a user may create an entry for a meeting and set first their spouse as the resource, then their babysitter as the backup or secondary resource. If the spouse declines, then the present embodiment may send an entry to the user's babysitter. However, if the babysitter accepts, then the regular calendar invite for the real meeting invitees may be sent out. Also, in the case where the babysitter declines, the user may then get prompted to either ask another person as the resource or reschedule the meeting. Additionally, the resource may also delegate or suggest a new time.

Furthermore, the present embodiment may also be used with respect to social network sites that display a user's trip information. As such, in order for the user to be able to take that trip, the person as a resource needs to be available and that information can be optionally displayed on social network sites as well.

FIG. 3 is a block diagram 300 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may be represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1) and network server 114 (FIG. 1) may include respective sets of internal components 800 a,b and external components 900 a,b illustrated in FIG. 3. Each of the sets of internal components 800 include one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and the Software Program 108 (FIG. 1) and the Person as a Resource for a Calendar Invitation program 116A (FIG. 1) in client computer 102 (FIG. 1) and the Person as a Resource for a Calendar Invitation program 116B (FIG. 1) in network server 114 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a,b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as the Software Program 108 (FIG. 1) and the Person as a Resource for a Calendar Invitation program 116A, 116B (FIG. 1) can be stored on one or more of the respective portable computer-readable tangible storage devices 936, read via the respective R/W drive or interface 832 and loaded into the respective hard drive 830.

Each set of internal components 800 a,b also includes network adapters or interfaces 836 such as a TCP/IP adapter cards, wireless Wi-Fi interface cards, or 3G or 4G wireless interface cards or other wired or wireless communication links. The Software Program 108 (FIG. 1) and the Person as a Resource for a Calendar Invitation program 116A (FIG. 1) in client computer 102 (FIG. 1) and the Person as a Resource for a Calendar Invitation Program 116B (FIG. 1) in network server 114 (FIG. 1) can be downloaded to client computer 102 (FIG. 1) and network server 114 (FIG. 1) from an external computer via a network (for example, the Internet, a local area network or other, wide area network) and respective network adapters or interfaces 836. From the network adapters or interfaces 836, the Software Program 108 (FIG. 1) and the Person as a Resource for a Calendar Invitation program 116A (FIG. 1) in client computer 102 (FIG. 1) and the Person as a Resource for a Calendar Invitation Program 116B (FIG. 1) in network server 114 (FIG. 1) are loaded into the respective hard drive 830. The network may comprise copper wires, optical fibers, wireless transmission, routers, firewalls, switches, gateway computers and/or edge servers.

Each of the sets of external components 900 a,b can include a computer display monitor 920, a keyboard 930, and a computer mouse 934. External components 900 a,b can also include touch screens, virtual keyboards, touch pads, pointing devices, and other human interface devices. Each of the sets of internal components 800 a,b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

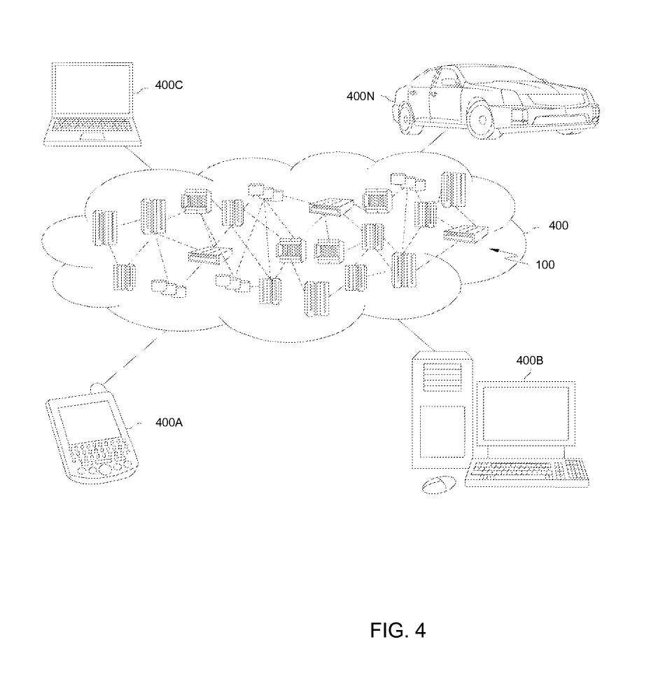

Referring now to FIG. 4, illustrative cloud computing environment 400 is depicted. As shown, cloud computing environment 400 comprises one or more cloud computing nodes 100 with which local computing devices used by cloud consumers, such as, for example, personal digital assistant (PDA) or cellular telephone 400A, desktop computer 400B, laptop computer 400C, and/or automobile computer system 400N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 400A-N shown in FIG. 4 are intended to be illustrative only and that computing nodes 100 and cloud computing environment 400 can communicate with any type of computerized device over any type of network and/or network addressable connection (e.g., using a web browser).

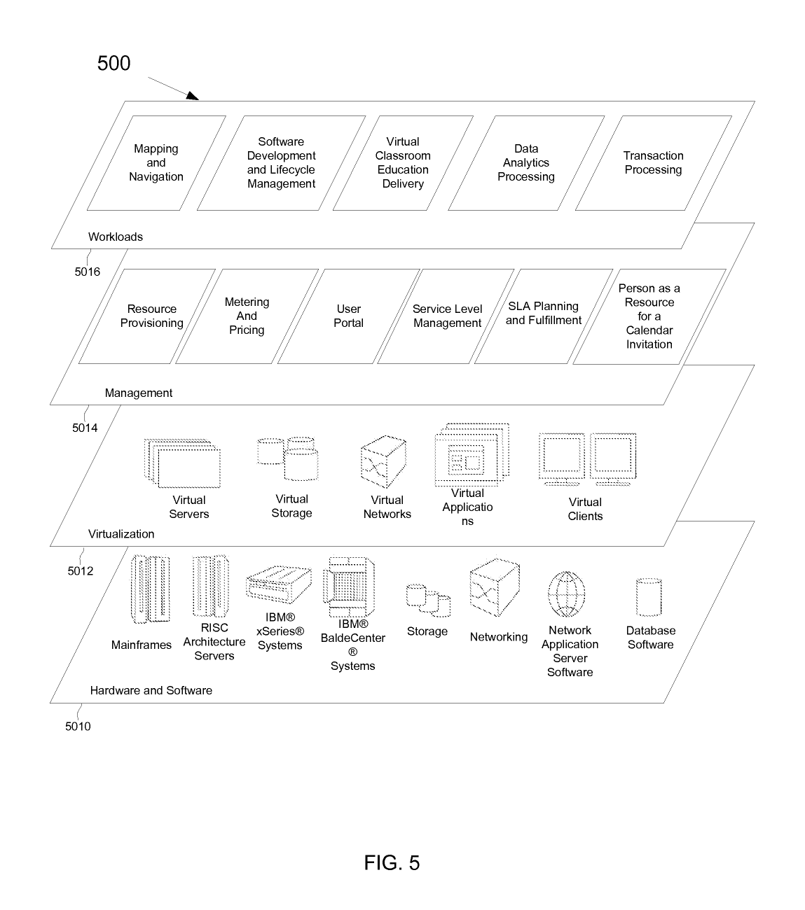

Referring now to FIG. 5, a set of functional abstraction layers 500 provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 5010 includes hardware and software components. Examples of hardware components include: mainframes; RISC (Reduced Instruction Set Computer) architecture based servers; storage devices; networks and networking components. In some embodiments, software components include network application server software.

Virtualization layer 5012 provides an abstraction layer from which the following examples of virtual entities may be provided: virtual servers; virtual storage; virtual networks, including virtual private networks; virtual applications and operating systems; and virtual clients.

In one example, management layer 5014 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A Person as a Resource for a Calendar Invitation program may enable a creator of a calendar entry to book a person as a resource for the calendar invitation.

Workloads layer 5016 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1.-8. (canceled)

9. A computer system for requesting a person to be available for a scheduled event, the computer system comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
providing a user interface (UI) for requesting at least one person to be available for an event;
detecting an entry via the UI requesting the at least one person to be available for the event;
detecting an entry via the UI for at least one invitee to be invited to the event;
confirming an availability of the at least one person and an availability of the at least one invitee based on the detection of the entry requesting the at least one person to be available for the event and the detection of the entry requesting the at least one invitee to be invited to the event;
sending a unique calendar invitation to the at least one person based on the confirmed availability of the at least one person and the confirmed availability of the at least one invitee; and
sending a calendar invitation to the at least one invitee based on the confirmed availability of the at least one person and the at least one invitee.

10. The computer system of claim 9, further comprising:
managing a plurality of reschedule information associated with the event; and
managing a plurality of update information associated with the event.

11. The computer system of claim 9, wherein the event can be selected from a group consisting of a meeting, an appointment, a phone conference, a game, a dinner, a presentation, and a scheduled out-of-office.

12. The computer system of claim 9, wherein the UI provides a plurality of options that can be selected from a group consisting of a plurality of rescheduling options, a plurality of acceptance ordering rules, a plurality of dependencies, and a plurality of alternatives.

13. The computer system of claim 9, wherein the scheduled event is associated with an online calendar invitation for a calendar event.

14. The computer system of claim 9, wherein the at least one person to be available for the event is not invited to the event.

15. The computer system of claim 9, wherein the UI allows a plurality of optional comments to be entered for the at least one person to be available for the event.

16. The computer system of claim 15, wherein the unique calendar invitation includes the plurality of optional comments.

17. A computer program product for requesting a person to be available for a scheduled event, the computer program product comprising:
one or more computer-readable storage devices and program instructions stored on at least one of the one or more tangible storage devices, the program instructions executable by a processor, the program instructions comprising:
program instructions to provide a user interface (UI) for requesting at least one person to be available for an event;
program instructions to detect an entry via the UI requesting the at least one person to be available for the event;
program instructions to detect an entry via the UI for at least one invitee to be invited to the event;
program instructions to confirm an availability of the at least one person and an availability of the at least one invitee based on the detection of the entry requesting the at least one person to be available for the event and the detection of the entry requesting the at least one invitee to be invited to the event;
program instructions to send a unique calendar invitation to the at least one person based on the confirmed availability of the at least one person and the confirmed availability of the at least one invitee; and
program instructions to send a calendar invitation to the at least one invitee based on the confirmed availability of the at least one person and the at least one invitee.

18. The computer program product of claim 17, further comprising:
program instructions to manage a plurality of reschedule information associated with the event; and
program instructions to manage a plurality of update information associated with the event.

19. The computer program product of claim 17, wherein the event can be selected from a group consisting of a meeting, an appointment, a phone conference, a game, a dinner, a presentation, and a scheduled out-of-office.

20. The computer program product of claim 17, wherein the UI provides a plurality of options that can be selected from a group consisting of a plurality of rescheduling options, a plurality of acceptance ordering rules, a plurality of dependencies, and a plurality of alternatives.
